(19) United States
(12) Patent Application Publication
(10) Pub. No.: US 2026/0235189 A1
(43) Pub. Date: Aug. 13, 2026

(54) CLAMPING DEVICE WITH FLEXIBLE EXIT BARRIER

(71) Applicant: GRIPPLE LIMITED, Sheffield, South Yorkshire (GB)

(72) Inventor: Samuel White, Sheffield, South Yorkshire (GB)

(21) Appl. No.: 19/150,802

(22) PCT Filed: Jan. 25, 2024
(86) PCT No.: PCT/IB2024/050696

§ 371 Date: Jul. 24, 2025

(30) Foreign Application Priority Data
Jan. 26, 2023 (GB) 2301110.9
Jan. 25, 2024 (GB) 2400982.1

(51) Int. Cl. F16G 11/10; B25B 25/00; F16B 2/14; F16G 11/04

(52) U.S. Cl. CPC F16G 11/106; B25B 25/00; F16B 2/14; F16G 11/048

(57) ABSTRACT

A clamping device (100) for clamping an elongate article (1, 2), the clamping device (100) comprising: a body (102) into which the elongate article (1, 2) is insertable; an entrance aperture (148, 248); an exit aperture (150, 250) adjacent to the entrance aperture (148, 248); and a flexible barrier (162, 262) proximal to the exit aperture (150, 250), wherein the flexible barrier (162, 262) is located relative to the exit aperture (150, 250) to be contactable by an end of the elongate article (1, 2), wherein force against the flexible barrier (162, 262) by the end of the elongate article (1, 2) deflects the flexible barrier (162, 262) in an opening direction to enable the end of the elongate article (1, 2) to leave the clamping device (100) through the exit aperture (150, 250), and wherein the clamping device (100) is configured to limit a range of flexure of the flexible barrier (162, 262) in the opening direction to an acute angle.

### FIELD OF THE INVENTION

Embodiments of the present invention relate to a clamping device with a flexible barrier proximal to an exit aperture. In particular, they relate to a clamping device for clamping an elongate article such as wire, wire rope, cable, or the like.

### BACKGROUND TO THE INVENTION

Clamping devices for securing elongate articles, in the form of cables or wire ropes, are known. It is known for a clamping device to comprise an internal spring to urge an internal clamping member against an elongate article. In some designs, the elongate article needs to be inserted in a correct direction, and if inserted in the opposite direction the clamping device may not work properly.

### BRIEF DESCRIPTION OF VARIOUS EMBODIMENTS OF THE INVENTION

According to various, but not necessarily all, embodiments of the invention there is provided a clamping device for clamping an elongate article, the clamping device comprising:
a body into which the elongate article is insertable;
an entrance aperture;
an exit aperture adjacent to the entrance aperture; and
a flexible barrier proximal to the exit aperture,
wherein the flexible barrier is located relative to the exit aperture to be contactable by an end of the elongate article,
wherein force against the flexible barrier by the end of the elongate article deflects the flexible barrier in an opening direction to enable the end of the elongate article to leave the clamping device through the exit aperture, and
wherein the clamping device is configured to limit a range of flexure of the flexible barrier in the opening direction to an acute angle.

An advantage is a more durable clamping device, because the maximum stress in the flexible barrier is limited; the flexure cannot be 90 or more degrees.

The flexible barrier may be confined within the clamping device to limit the range of flexure of the flexible barrier in the opening direction to the acute angle.

An advantage is further durability because the flexible barrier is confined within the clamping device rather than being wholly at an exposed exterior of the clamping device.

The clamping device may comprise an end stop to prevent further flexure of the flexible barrier in the opening direction, beyond the acute angle. The end stop may comprise an abutment surface contactable by the flexible barrier. The flexible barrier may become more parallel to the end stop as the flexible barrier is deflected in the opening direction.

In a neutral unflexed state, the flexible barrier may extend at a first angle relative to the end stop. The first angle may be an acute angle relative to the end stop. Therefore, the angular separation between the first angle and the end stop may be an acute angle. The angular separation may be a value less than 60 degrees, such as approximately 45 degrees.

The clamping device may further comprise a second end stop to prevent flexure of the flexible barrier from the neutral unflexed state in an opposite direction than the opening direction, beyond an acute angle. The second end stop may comprise an abutment surface contactable by an abutter of the flexible barrier, to limit the flexure to an acute angle. The abutter may comprise a boss.

The first angle may be in a direction that inhibits insertion of the elongate article via the exit aperture, and enables the elongate article to exit the clamping device via the exit aperture.

An advantage of the flexible barrier is preventing wrong-way insertion of the elongate article. This is better than using visual markers such as arrows, which may be misinterpreted or not noticed by some users. However, in some examples, arrows may additionally be depicted on the body of the clamping device.

The exit aperture may be adjacent to the entrance aperture by being located to a same end of the clamping device as the entrance aperture. The flexible barrier may block the exit aperture but not the entrance aperture. Therefore, the entrance aperture may be an unblocked aperture whereas the exit aperture may be a blocked aperture due to the flexible barrier. The flexible barrier may be visible from an exterior of the clamping device, such as by being closer to the exit aperture than to a clamp of the clamping device.

An advantage is that the flexible barrier provides a visual reference indicating which aperture the elongate article should be inserted into.

The flexible barrier may comprise a flexible hinge supporting a contact member. The contact member may be located relative to the exit aperture to be contactable by an end of the elongate article. Force against the contact member of the flexible barrier by the end of the elongate article may deflect the contact member in the opening direction to enable the end of the elongate article to leave the clamping device through the exit aperture. The clamping device may be configured to limit a range of flexure of the flexible hinge of the flexible barrier in the opening direction to the acute angle.

The flexible hinge may comprise a living hinge. The living hinge may be thinner than the contact member. The living hinge may be formed from a same material as the contact member. The end stop may be formed from the same material. The material may be a plastics material. The flexible barrier and the end stop may be a single moulded part.

An advantage is ease of manufacture. The living hinge is protected because the living hinge cannot be flexed in the opening direction by more than the acute angle.

The flexible barrier may be enveloped within the body of the clamping device. The flexible barrier may be enveloped within the body of the clamping device regardless of whether the flexible barrier is closed or is sufficiently open to enable the elongate article to pass through. The flexible barrier may be enveloped within the body of the clamping device regardless of a position of the flexible barrier within deflection limits of the flexible barrier.

An advantage is improved durability because the flexible barrier is protected within the clamping device. Another advantage is that the external objects cannot interfere with opening of the flexible barrier.

The flexible barrier may be flexible about an axis substantially perpendicular to a plane. The plane may be a plane of clamp movement of the clamping device, and/or a plane along which one or more elongate articles are configured to extend, within the clamping device. When the flexible barrier is deflected in the opening direction, a restoring force direction of the flexible barrier may be in the plane.

When the flexible barrier is deflected in the opening direction, a restoring force direction of the flexible barrier may be approximately orthogonal to a plane of a surface in the clamping device along which the elongate article is configured to extend when clamped.

An advantage is improved alignment because the forces against the side of the elongate article—the clamping force from the clamp and a smaller force from the deflected barrier—are in a common plane.

The clamping device may comprise a part, adjacent to the exit aperture, to which the flexible barrier is mounted. The part may comprise an end cap and/or a spring seat. The part may be an end cap comprising a spring seat and the flexible barrier. A side surface of the part may further define the end stop referred to earlier. The part may be the single-moulded part referred to earlier. The clamping device may comprise a clamp. The clamp may comprise a clamping surface. The clamping surface may be serrated. The clamp may be wedge-shaped or may be round. If wedge-shaped, the clamp may comprise a wedging surface, opposite the clamping surface.

The clamping device may comprise a spring configured to urge the clamp into clamping engagement with the elongate article. The spring may be configured to resist movement of the clamp out of clamping engagement with the elongate article. The spring may be seated against the clamp and against the part that comprises the flexible barrier. The spring may comprise a coil spring. The spring may comprise a compression spring.

The clamping device may comprise a releaser movable from a home position to a release position to move the clamp out of clamping engagement with the elongate article. The releaser may comprise an input button depressible by a digit of a user. Depressing the releaser may push the clamp out of clamping engagement with the elongate article. The spring may be compressed as the releaser moves to the release position.

The clamp may be slidable at an oblique angle relative to a passage along which the elongate article extends in use. The clamp may be slidable in the plane of clamp movement of the clamping device, at the oblique angle. The oblique angle may have a value less than 30 degrees or less than 20 degrees. If the clamp is wedge-shaped, an angle of taper of the clamp may be equal to the oblique angle relative to the passage.

An advantage of this low angle is the clamp can be slid easily to clamp against the wire rope, but can also be released easily. A lower value of the oblique angle enables higher clamping force, whereas a steeper angle enables improved ease of release.

The clamping device may comprise a first clamping formation, against which the clamp may be configured to clamp the elongate article. The clamping formation may be a clamping wall. The clamping wall may extend along the passage.

The clamping device may comprise a second clamping formation for applying a clamping force to the clamp. Thus, the clamp and the elongate article are clamped between the first and second clamping formations. The second clamping formation may be a second clamping wall. The second clamping formation may converge towards the first clamping formation at the oblique angle relative to the first passage.

The clamping surface of the clamp may be parallel to the first clamping formation. The wedging surface of the clamp may be parallel to the second clamping formation.

Regarding the flexible barrier, the first angle at which the flexible barrier extends may be an oblique angle relative to the passage.

It will be appreciated that the oblique angle along which the clamp can slide relative to the first clamping formation gives the clamping device a ‘handedness’. Elongate articles can only be easily inserted in one direction. If the end of the elongate article is inserted in the correct insertion direction, the end of the elongate article pushes the clamp away from the first clamping formation at the oblique angle. This creates space between the first clamping formation and the clamp, enabling the elongate article to be pushed past the clamp such that the clamp can engage with the side of the elongate article. Once engaged, the elongate article is clamped against being pulled back. However, if the end of the elongate article is inserted into the clamping device in the incorrect, opposite insertion direction, the end of the elongate article cannot push the clamp out of the way. This is because the end of the elongate article is pushing the clamp towards the first clamping formation at the oblique angle.

The clamping device may comprise a plurality of passages. The entrance aperture and exit aperture may be apertures for separate passages of the clamping device. The body of the clamping device may define a plurality of passages for receiving one or more elongate articles, the plurality of passages comprising a first passage and a second passage. The entrance aperture may be a first entrance aperture for accessing the first passage. The clamping device may comprise a first exit aperture for exiting the first passage. The clamping device may further comprise a second entrance aperture for accessing the second passage. The exit aperture may be a second exit aperture for exiting the second passage.

An advantage of multiple passages is a more versatile clamping device because it can be used to secure multiple elongate articles, or a single loop of the elongate article.

The first exit aperture may be adjacent the second entrance aperture. The first entrance aperture and second exit aperture may be to the same, first end of the clamping device. The second entrance aperture and first exit aperture may be to a same, second end of the clamping device, opposite the first end of the clamping device. The clamping device may comprise another one of the flexible barrier, proximal to the first exit aperture. The flexible barrier proximal to the first exit aperture may be a first barrier and the flexible barrier proximal to the second exit aperture may be a second barrier.

The clamping device may comprise a separate end stop for each barrier. Each end stop may be as described above. Each end stop may be part of a separate end cap. Each end cap/part comprising the respective barrier may be located to a respective opposite one of the first and second ends of the clamping device. The clamping device may comprise a plurality of the clamps. Each passage may be associated with a different one of the clamps. Each clamp may apply clamping force in an opposite direction to the other.

The clamping device may comprise a plurality of the springs. Each passage may be associated with a different one of the springs. The clamping device may comprise a plurality of the end caps. Each passage may be associated with a different one of the end caps. The clamping device may comprise a plurality of the first and second clamping formations, wherein each passage is associated with a different pair of the first and second clamping formations. The clamping device may comprise a plurality of the releasers, wherein each passage is associated with a different one of the releasers. The releasers and end caps may be to the opposite first and second ends of the clamping device.

### BRIEF DESCRIPTION OF THE DRAWINGS

For a better understanding of various examples of embodiments of the present invention reference will now be made by way of example only to the accompanying drawings in which:

FIG. 1 illustrates an example of a clamping device;

FIG. 2 illustrates a side cross-section of the clamping device with releasers not actuated;

FIG. 3 illustrates a side cross-section of the clamping device with releasers actuated;

FIG. 4 illustrates an end cross-section through a centre of the clamping device;

FIG. 5 illustrates a clamp;

FIG. 6 illustrates an end view of a releaser, and an end cap comprising a flexible barrier; and

FIG. 7 illustrates an end cap to which a spring is seated.

### DETAILED DESCRIPTION OF VARIOUS EMBODIMENTS OF THE INVENTION

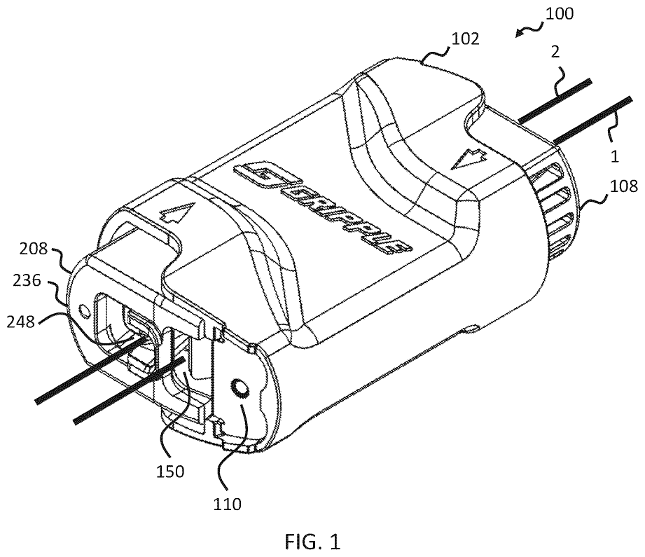

FIG. 1 illustrates an example clamping device 100 for clamping elongate articles 1, 2. The elongate articles 1, 2 may be in the form of a wire, wire rope, cable, or the like. The elongate articles 1, 2 may be separate wires, joined end to end by the clamping device 100. Alternatively, the elongate articles 1, 2 may be the same wire such that the clamping device 100 secures a loop of the wire. In another implementation, the clamping device 100 is for clamping only one elongate article 1 once.

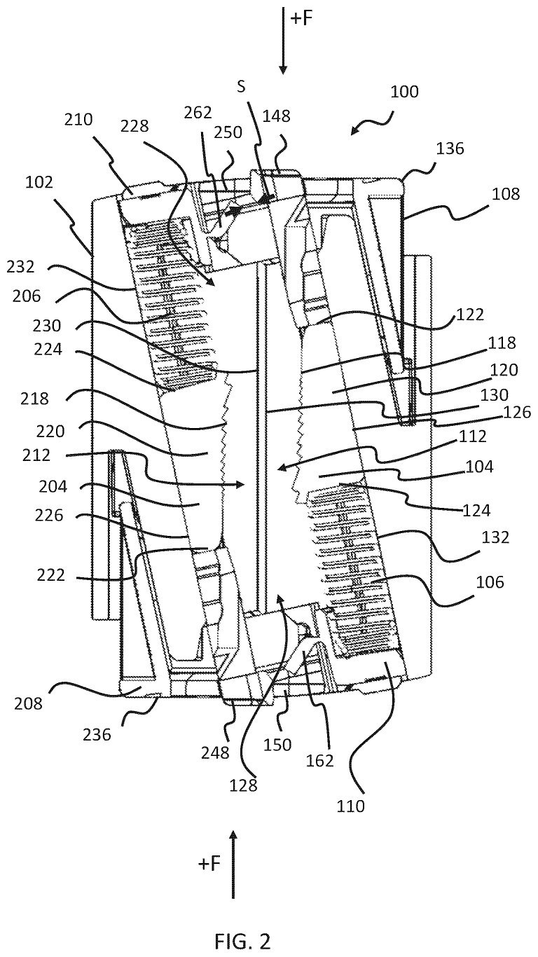

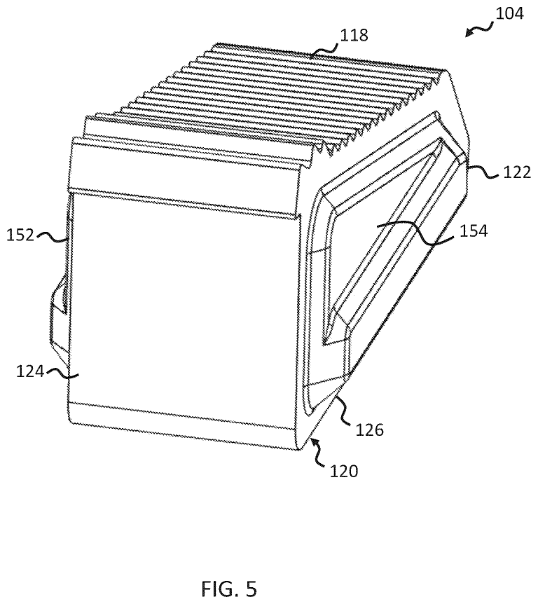

The clamping device 100 comprises a body 102 and internal components within the body 102 as shown in the cross-section views of FIGS. 2 to 4 and the component views of FIGS. 5 to 7.

The internal components include clamps 104, 204. Each clamp 104, 204 is an effector for engaging with an elongate article 1, 2.

As shown in FIGS. 2-4 and 5, each clamp 104, 204 comprises an elongate clamp body 120, 220 in the form of a clamping wedge. The clamp body 120, 220 may be a wedge-shaped prism. The clamp body 120, 220 is movable within the clamping device 100. The clamp 104, 204 is not limited to the specific shape and configuration shown. For example, the clamp 104, 204 can have another suitable shape, such as a round shape defining a roller.

Each clamp body 120, 220 has a leading end 122, 222 and an opposite, trailing end 124, 224. In use, each clamp 104, 204 can be urged into engagement with the elongate article 1, 2 in a direction in which the leading end 122, 222 leads the trailing end 124, 224.

Each clamp body 120, 220 comprises a clamping surface 118, 218 extending therebetween. The clamping surface 118, 218 has a plurality of parallel serrations to provide tight engagement with the elongate article 1, 2. As shown, the serrations may extend perpendicular to the axis of the elongate article 1, 2. The opposite surface of the clamp body 120, 220, behind the clamping surface 118, 218, is a wedging surface 126, 226. The wedging surface 126, 226 faces an internal wall 132, 232 of the clamping device 100 and can contact the internal wall 132, 232 to wedge the clamp 104, 204 and the elongate article 1, 2 between a pair of tapering internal walls 130-132 or 230-232. In some examples, the wedging surface 126, 226 is a sliding surface configured to slide along the internal wall 132, 232.

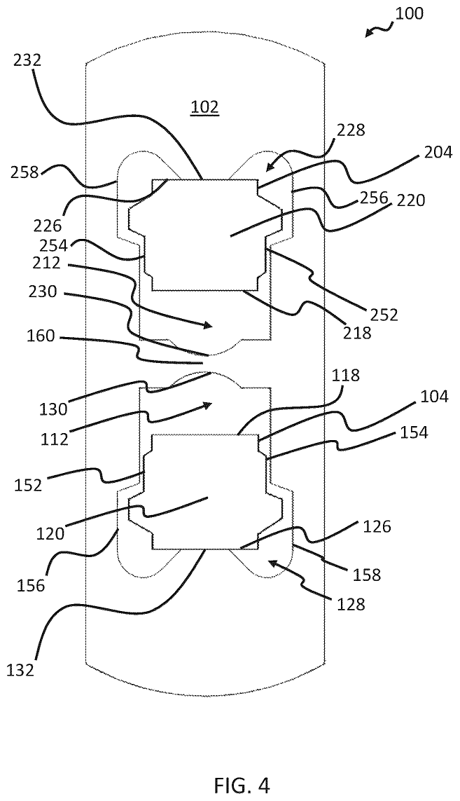

As shown in FIGS. 4-5, each clamp body 120, 220 also has left and right sides 152-154 and 252-254 (side surfaces) interconnecting the clamping surface 118, 218 and the wedging surface 126, 226.

The wedging surface 126, 226 of the clamp body 120, 220 tapers inwardly from the trailing end 124, 224 to the leading end 122, 222, to create the wedge shape. The tapering of the wedging surface 126, 226 may be a uniform taper from said trailing end 124, 224 to said leading end 122, 222. The clamp 104, 204 has a height which reduces approximately uniformly from the trailing end 124, 224 to the leading end 122, 222 to form the wedge configuration.

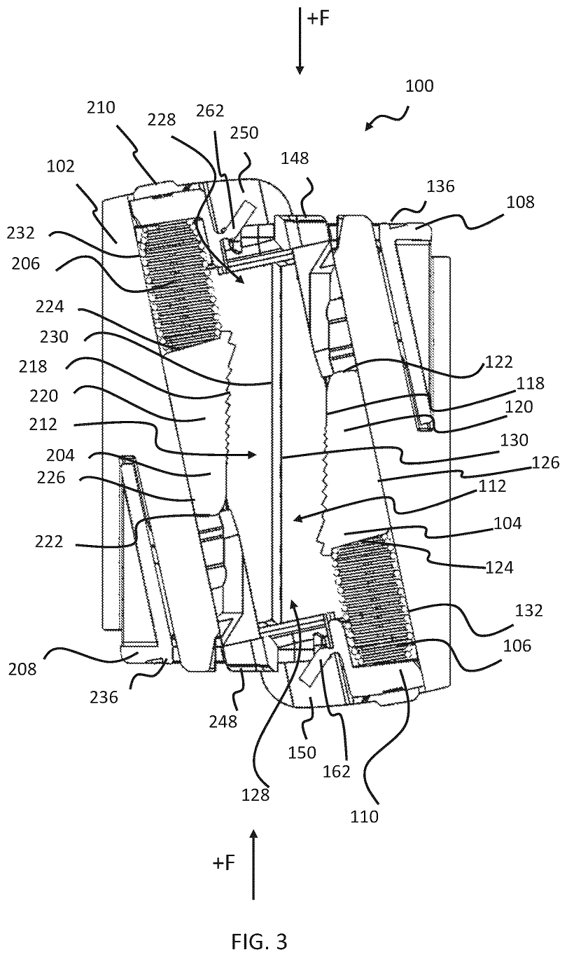

As shown in FIGS. 2-3, a spring 106, 206 wedges each clamp 104, 204 into a small area of an internal space 128, 228 within the clamping device 100 so that the clamping surface 118, 218 of the clamp 104, 204 is biased against the side of the elongate article 1, 2. The spring 106, 206 ensures that the clamp 104, 204 stays in its required clamping position in use. One end of the spring 106, 206 is in contact with a trailing end 124, 224 of the clamp 104, 204. As best shown in FIG. 7, the other end of the spring 106, 206 is in contact with a spring seat 111 of an end cap 110, 210.

In use, an elongate article 1, 2 can be fed through the clamping device 100 in a feed direction +F. The feed direction +F is dependent on the direction of the spring 106, 206 and the direction of movement of the clamp 104, 204, which are at an oblique angle relative to the elongate article 1, 2. Once fed into the clamping device 100, clamp 104, 204 is in clamping engagement with the side of the elongate article 1, 2 to prevent slippage.

The oblique angle may be a value that is less than 45 degrees. The oblique angle may be a value that is less than 30 degrees. The oblique angle may be a value that is greater than 5 degrees. The oblique angle may be a value of approximately 12 degrees, for an optimum balance between clamping force and ease of release.

Insertion of the elongate article 1, 2 is possible by feeding the elongate article 1, 2 along its axis in the feed direction +F through a suitable opening arrangement 148-150 or 248-250 of the clamping device 100, through an internal passage 112, 212 connecting the openings 148-150, 248-250 of the opening arrangement. In the illustrated example, the opening arrangement comprises an entrance aperture 148, 248 and an exit aperture 150, 250 opposite the entrance aperture 148, 248. The elongate article 1, 2 cannot readily be inserted through an exit aperture 150, 250 because this would be resisted by the clamp 104, 204.

The shape of the internal space 128, 228 of the clamping device 100 can play a role in enabling the clamp 104, 204 to apply a force to the elongate article 1, 2. As shown in FIG. 4, the space 128, 228 is bounded by walls of the body 102 including a first clamping wall 130, 230, a second clamping wall 132, 232, and side walls 156-158, 256-258 connecting the first and second clamping walls 130, 230 and 132, 232. The first clamping wall 130, 230 is the surface against which a side of the elongate article 1, 2 is compressed. The second clamping wall 132, 232 is the tapering surface against which the wedging surface 126, 226 of the clamp 104, 204 is wedged.

As shown in FIGS. 2-4, the first clamping wall 130, 230 may extend from the entrance aperture 148, 248 towards the exit aperture 150, 250. As shown in FIG. 4, the illustrated first clamping wall 130, 230 comprises an optional groove along its length, along which to seat the elongate article 1, 2.

As shown in FIG. 4, the body 102 of the clamping device 100 can comprise a partition 160 dividing the internal spaces 128 and 228 from each other. The opposite surfaces of the partition 160 may form the first clamping walls 130, 230 for the respective internal spaces 128, 228.

The partition 160 may extend in a straight line between the entrance and exit apertures 148-150/248-250, such that the passages 112, 212 are substantially straight and parallel to each other. However, in other examples, the paths of the passages 112, 212 may be nonparallel.

As shown in FIGS. 2-4, the second clamping wall 132, 232 is a surface against which the clamp 104, 204 can be slid. The second clamping wall 132, 232 tapers towards the first clamping wall 130, 230 with increasing proximity to the entrance aperture 148, 248. Therefore, the second clamping wall 132, 232 is a ramp for the clamp 104, 204.

As a result, the internal space 128, 228 within the body 102 of the clamping device 100 has a reducing cross-sectional area towards the entrance aperture 148, 248, because the second clamping wall 132, 232 tapers towards the first clamping wall 130, 230. The spring 106, 206 slides the clamp 104, 204 along the second clamping wall 132, 232, towards the entrance aperture 148, 248, wedging the clamp 104, 204 into the progressively narrowing gap between the first and second clamping walls 130, 230 and 132, 232. This forces the clamping surface 118, 218 of the clamp 104, 204 against the side of the elongate article 1, 2.

The clamp 104, 204 is wedged by the spring 106, 206 between the second clamping wall 132, 232 and the side of the elongate article 1, 2. The elongate article 1, 2 is wedged between the clamping surface 118, 218 of the clamp 104, 204 and the first clamping wall 130, 230 of the clamping device 100.

In use, if the elongate article 1, 2 is pulled in the feed direction +F, generally opposing the direction of the urging force (restoring force) of the spring 106, 206, the clamp 104, 204 is pushed out of the way of the passage 112, 212. This overcomes the urging of the deflected (e.g., compressed) spring 106, 206. This enlarges the passage 112, 212 along which the elongate article 1, 2 can be drawn, and allows the elongate article 1, 2 to be pulled through the exit aperture 150, 250. The clamp 104, 204 provides limited resistance to pulling the elongate article 1, 2 in the feed direction +F.

When the elongate article 1, 2 has been received through the clamping device 100, the clamping surface 118, 218 of the clamp 104, 204 engages the side of the elongate article 1, 2 in the passage 112, 212.

If the clamped elongate article 1, 2 is pulled in the reverse direction-F opposite the feed direction +F, this has the effect of pulling the clamp 104, 204 with the elongate article 1, 2 into the narrowing gap between the first and second clamping walls 130, 230 and 132, 232, thereby tightly clamping the elongate article 1, 2 and the clamp 104, 204 between the first and second clamping walls 130, 230 and 132, 232.

As shown in FIGS. 1-3, the second clamp 204 may apply clamping force in an opposite direction than the first clamp 104. The clamping forces of the clamps 104 and 204 may be coplanar and in opposite directions. As a result, the elongate articles 1 and 2 should be fed from opposite ends of the clamping device 100.

Therefore, the entrance aperture 148 for the first passage 112 is adjacent the exit aperture 150 for the second passage 212, at a first end of the clamping device 100. Likewise, at a second, opposite end of the clamping device 100, the entrance aperture 248 for the second passage 212 is adjacent the exit aperture 150 for the first passage 112.

It is desirable to provide a means for releasing the clamping force to enable the elongate article 1, 2 to be withdrawn from the clamping device 100 in a direction -F opposite the feed direction +F. Therefore, releasers 108, 208 are provided. One of the releasers 108 is for releasing the first elongate article 1 in the first passage 112, and the other of the releasers 208 is for releasing the second elongate article 2 in the second, parallel passage 212. The illustrated releasers 108, 208 are connected to the same body 102. The illustrated releasers 108, 208 are located to the opposite ends of the body 102. The illustrated releasers 108, 208 are located to opposite corners of the body 102. However, they could be elsewhere such as along the side of the body 102.

Each illustrated releaser 108, 208 (FIGS. 1-3) enables the user to move the clamp 104, 204 out of the way, causing the clamping surface 118, 218 of the clamp 104, 204 to disengage from the elongate article 1, 2.

FIGS. 1-3 illustrate an example releaser 108, 208 comprising an input button 136, 236 which can be pressed by a digit of the user.

In FIG. 2, the releasers 108, 208 are in their home positions whereas in FIG. 3, the releasers 108, 208 are in their release positions.

For as long as the releaser 108, 208 is pushed (e.g., slid) into its release position, moving the clamp 104, 204, the elongate article 1, 2 can be withdrawn in the reverse direction-F.

The releaser 108, 208 actuates the leading end 122, 222 of the clamp body 120, 220. The input button 136, 236 pushes the releaser 108, 208 against the clamp 104, 204, to poke the clamp 104, 204 in a reverse direction to the wider space of the clamping device 100. FIG. 3 illustrates the resulting path of the clamp 104, 204, which in this case is the oblique angle defined above.

Depressing (pushing) the input button 136, 236 therefore pokes the clamp 104, 204 towards a wider part of the internal space 128, 228, towards the exit aperture 150, 250. This releases the elongate article 1, 2.

Actuating the releaser 108, 208 to the release position deflects (e.g., compresses) the spring 106, 206, which applies a reaction force back towards the narrower part of the internal space 128, 228.

Therefore, if user stops actuating the releaser 108, 208, the spring 106, 126 will push the clamp 104, 204 back into its clamping position in which the clamp 104, 204 is in clamping engagement with the elongate article 1, 2.

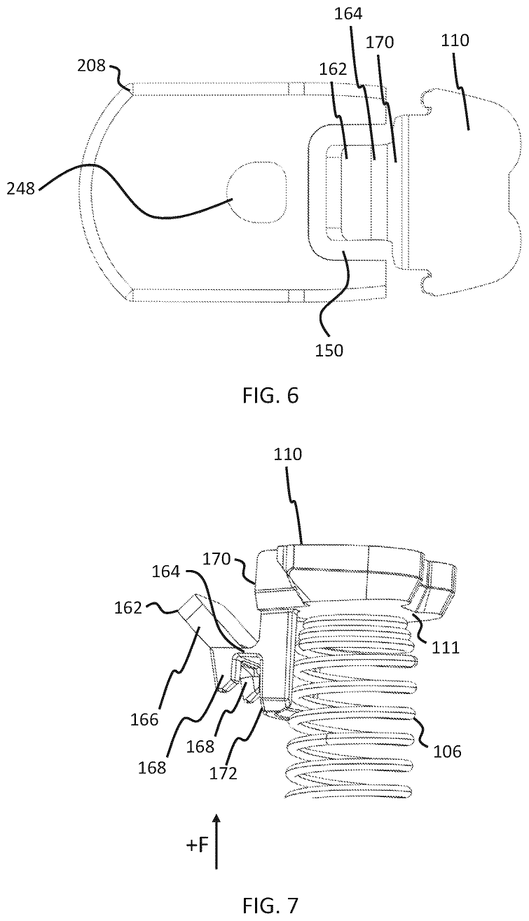

As best shown in FIGS. 1 and 6, the entrance aperture 148, 248 of a given passage 112, 212 can be defined by a hole through the releaser 108, 208. The exit aperture 250, 150 of the adjacent passage 212, 112 can comprise a gap between the releaser 108, 208 and the adjacent end cap 110, 210, the gap defining a hole/aperture.

The illustrated clamping device 100 is push-to-release. In other implementations, the releaser 108, 208 could be actuated in another manner. In relation to the materials and manufacture, the body 102 may be formed from a metallic material such as zinc, steel, aluminium, or any other appropriate metal. In an example, the body 102 may be die cast zinc. The releaser 108, 208 may optionally be formed from a plastics material.

As mentioned earlier, the elongate article 1, 2 cannot readily be inserted through an exit aperture 150, 250 because this would be resisted by the clamp 104, 204. However, since the exit apertures 150, 250 are adjacent to the entrance apertures 148, 248, it may not be clear to an installer which one is the exit aperture and which one is the entrance aperture. The embossed arrows depicted in FIG. 1 and aligned with the entrance apertures 148, 248 may not be noticed by some installers.

Therefore, as shown in FIGS. 2-3 and 6-7, the clamping device 100 comprises a flexible barrier 162, 262 proximal to each exit aperture 150, 250.

The flexible barrier 162, 262 is a movable gate which is movable by the end of an elongate article 1, 2 to enable the end of the elongate article 1, 2 to be fed through the exit aperture 150, 250 when inserted in the correct, feed direction +F.

The illustrated barrier 162, 262 is visible through the exit aperture 150, 250. The flexible barrier 162, 262 is close to the exit aperture 150, 250, being sub-flush relative to the exit aperture 150, 250. This indicates to the installer that they should not attempt to insert the elongate article 1, 2 through the aperture 150, 250.

In examples, the flexible barrier 162, 262 is movable via resilient deformation. As shown in FIG. 7, the flexible barrier 162, 262 comprises a flexible hinge 164 supporting a contact member in the form of a flap 166 of material. The illustrated flap 166 substantially blocks the exit aperture 150, 250, when in a neutral unflexed state. The flexible hinge 164 enables the resilient deformation.

The flap 166 is shown cantilevered from the flexible hinge 164. The flexible hinge 164 can be in the form of a living hinge of locally thinned material, relative to a material thickness of the flap 166.

The flexible hinge 164 is fixedly supported by a part of the clamping device 100 proximal to the exit aperture 150, 250. In the illustrated example, the end cap 110, 210 is the part which comprises and supports the flexible barrier 162, 262. The end cap 110, 210 and the flexible barrier 162, 262 may be an integrally-moulded plastics part.

The illustrated flexible hinge 164 is connected to an interior side of the end cap 110, 210, in the internal space 128, 228 of the clamping device 100. The flexible barrier 162, 262 is sub-flush with respect to the exit aperture 150, 250.

The axis of the flexible hinge 164 is substantially perpendicular to the plane of the side cross-section in FIGS. 2-3, that is the plane in which clamp movement is possible and the plane along which the elongate articles 1, 2 extend. Therefore, the restoring force of the flexible hinge 164 is substantially in the plane, and substantially towards the first clamping wall 130, 230 (notwithstanding that illustrated wall 130, 230 stops short of the flexible barrier 162, 262).

A proximal end (fixed end) of the flap 166 of the flexible barrier 162, 262 is connected to the flexible hinge 164, whereas a distal end (free end) of the flap 166 of the flexible barrier 162, 262 is separated from an adjacent boundary of the clamping device 100.

When the flap 166 is undeflected, the flexible barrier 162, 262-to-boundary separation ‘S’ (FIG. 2) is a distance less than the nominal maximum diameter of the elongate article 1, 2 that the clamping device 100 is configured to be compatible with. For example, the separation S may be less than two millimetres or less than 1.5 millimetres. Therefore, the elongate article 1, 2 cannot pass the flexible barrier 162, 262 without first deflecting the flap 166 to increase the separation.

As shown in FIG. 2, the flexible barrier 162, 262 is proximal to a side of an adjacent releaser 208, 108, such that the separation S is between the distal end of the flexible barrier 162, 262 and a side of the releaser 208, 108.

Pushing of the flap 166 by the end of a correctly-inserted elongate article 1, 2 inserted in the feed direction +F, deflects (rotates) the flap 166 in an opening direction (up in FIG. 7), about the flexible hinge 164. This enables the end of the elongate article 1, 2 to leave the clamping device 100 through the exit aperture 150, 250.

As the flap 166 is deflected about the flexible hinge 164, the separation S increases. Once the separation S becomes at least equal to the diameter of the elongate article 1, 2 (‘minimum separation’), the end of the elongate article 1, 2 can pass through the space around the flap 166.

The flexible barrier 162, 262 is confined within the clamping device 100 so that the flexible barrier 162, 262 and flexible hinge 164 are internal with respect to the exit aperture 150, 250. The opening direction of the flap 166 may be towards the exit aperture 150, 250.

With the flap 166 opened in the opening direction by the minimum separation, sufficiently open to enable the elongate article 1, 2 to pass through the flexible barrier 162, 262, the flap 166 may remain within the envelope of the body 102 of the clamping device 100. This geometry prevents collision of the flap 166 with external objects, and means that the overall dimensions of the clamping device 100 are unaffected.

With the flap 166 deflected in the opening direction to the minimum separation, the flap 166 may remain sub-flush, or no more than flush, with respect to the exit aperture 150, 250. This ensures that the flap 166 is within the internal space 128, 228 at all times.

In some, but not necessarily all examples, the flexible barrier 162, 262 is configured as a one-way gate. The flexible barrier 162, 262 is shaped to block insertion of an elongate article 1, 2 in the reverse direction-F through the exit aperture 150, 250, while enabling an elongate article 1, 2 pulled in the feed direction +F to exit the clamping device 100 through the exit aperture 150, 250. To enable the one-way behaviour, the flap 166 of the flexible barrier 162, 262 is orientated at an oblique angle relative to the corresponding passage 112, 212. The flap 166 is angled to minimise the deflection in the opening direction to achieve the minimum separation. In the illustrations, the flap 166 is orientated at an acute angle towards a plane of the exit aperture 150, 250/away from the passage 112, 212.

The acute angle of the flap 166 is configured so that if an elongate article 1, 2 is inserted in the feed direction +F, the minimum separation is achieved by deflection of the flap 166 by an acute angle. This makes it easy to deflect the flexible barrier 162, 262 out of the way.

However, if the insertion is in the opposite, prohibited direction-F, the flap 166 would need to be deflected by an obtuse angle to achieve the minimum separation. Such deflection may not even be possible. Attempting insertion in the prohibited direction-F may require the user to damage the flexible barrier 162, 262 which may involve significant force.

In the example of FIGS. 2-3 and 6-7, the flexible barrier 162, 262 is confined within the clamping device 100 to limit the range of deflection of the flexible hinge 164 in the opening direction to the acute angle. As best shown in FIGS. 6-7, deflection limits of the flexible barrier 162, 262 are defined by end stops in the form of abutment surfaces 170, 172, and result from confinement of the flexible barrier 162, 262 within the clamping device 100.

FIGS. 6-7 show a first end stop in the form of a first abutment surface 170, which is abutted when the flap 166 is deflected from the neutral unflexed state in the opening direction by insertion of the end of the elongate article 1, 2 (not shown) in the feed direction +F.

The first abutment surface 170 is configured to limit a range of flexure of the flexible hinge 164 in the opening direction to an acute angle. The acute angle may be no more than 45 degrees or no more than 60 degrees, relative to the neutral unflexed state.

In the neutral unflexed state of the flexible barrier 162, 262, the internal angle between the flap 166/flexible hinge 164 and the first abutment surface 170 may be equal to the acute angle.

The illustrated first abutment surface 170 is located to a first side of the flexible hinge 164. As shown, the first abutment surface 170 can be a portion of a side surface of the part to which the flexible hinge 164 of the flexible barrier 162, 262 is connected. In the illustrated example, the part is the end cap 110, 210. As shown in FIG. 7, the side surface may be a surface of a dividing protrusion of the end cap 110, 210 separating the flexible barrier 162, 262 from the spring seat 111. The first abutment surface 170 is the portion of the surface extending from the flexible hinge 164 towards the exit aperture 150, 250.

As the flap 166 is deflected in the opening direction, the internal angle between the flap 166 and the first abutment surface 170 decreases, becoming more parallel, until the flap 166 abuts the first abutment surface 170. As shown, the first abutment surface 170 may extend generally parallel to the first clamping walls 130, 230.

With the flap 166 deflected into abutment with the first abutment surface 170, the flap 166 may still remain within the envelope of the body 102 of the clamping device 100. With the flap 166 deflected into abutment with the first abutment surface 170, the flap 166 may remain sub-flush, or no more than flush, with respect to the exit aperture 150, 250.

FIG. 7 shows a second end stop in the form of a second abutment surface 172, which is abutted by part of the flexible barrier 162, 262 when the flap 166 of the flexible barrier 162, 262 is deflected in the neutral unflexed state in a second direction (down in FIG. 7) opposite the opening direction, by insertion of the end of the elongate article 1, 2 in the prohibited direction-F.

The illustrated second abutment surface 172 is located to an opposite second side of the flexible hinge 164. The second abutment surface 172 may be at 180 degrees relative to the first abutment surface 170. As shown, the second abutment surface 172 can be a portion of the same side surface of the same part (e.g., end cap 110, 210) to which the flexible hinge 164 of the flexible barrier 162, 262 is connected.

As shown in FIG. 7, the illustrated second abutment surface 172 is arranged to be contacted by abutters 168 (or one abutter 168) mounted to the flexible barrier 162, 262. In the illustrated example, the abutters 168 are bosses protruding from the underside of the flexible hinge 164. As the flap 166 is deflected in the second direction, the abutters 168 rotate about the axis of the flexible hinge 164 until the abutters 168 contact the second abutment surface 172. The abutters 168 contact the second abutment surface 172 before the flap 166 reaches the second abutment surface 172, to limit total flexure.

The combination of the second abutment surface 172 and the abutters 168 may limit a range of flexure of the flexible hinge 164 in the second direction to an acute angle. The acute angle may be no more than 45 degrees or no more than 60 degrees, relative to the neutral unflexed state. This prevents the flexible hinge 164 from being deformed by more than an acute angle in either direction from the neutral unflexed state, to limit fatigue stress regardless of which direction the elongate article 1, 2 pushes the flexible barrier 162, 262 from.

The second abutment surface 172 and the abutters 168 may be arranged to make contact before the flap 166 has rotated in the second direction by enough of an angle to provide the minimum separation for the passing of the end of the elongate article 1, 2. Therefore, if wrong-way insertion of an elongate article 1, 2 is attempted, the abutment of the abutters 168 against the second abutment surface 172 will physically prevent the flexible barrier 162, 262 from opening sufficiently to enable passing of the end of the elongate article 1, 2.

Overall, the total range of flexure of the flexible hinge 164 in both directions from the neutral unflexed state may be limited to no more than 90 degrees or no more than 120 degrees.

Although embodiments of the present invention have been described in the preceding paragraphs with reference to various examples, it should be appreciated that modifications to the examples given can be made without departing from the scope of the invention as claimed. For example, a clamping device 100 with a single one-way passage could benefit from a flexible barrier 162, 262 described herein. For example, the clamping device 100 could comprise a single curved passage connecting an entrance aperture to an exit aperture 150, 250 adjacent the entrance aperture at the same end as the entrance aperture.

Further, the manner in which the elongate article 1, 2 is clamped may vary from that shown. If the clamping device 100 only enables insertion in one direction, a flexible barrier 162, 262 may be beneficial.

Features described in the preceding description may be used in combinations other than the combinations explicitly described.

Although functions have been described with reference to certain features, those functions may be performable by other features whether described or not. Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A clamping device for clamping an elongate article, the clamping device comprising:
a body into which the elongate article is insertable;
an entrance aperture;
an exit aperture adjacent to the entrance aperture; and
a flexible barrier proximal to the exit aperture,
wherein the flexible barrier is located relative to the exit aperture to be contactable by an end of the elongate article,
wherein force against the flexible barrier by the end of the elongate article deflects the flexible barrier in an opening direction to enable the end of the elongate article to leave the clamping device through the exit aperture, and
wherein the clamping device is configured to limit a range of flexure of the flexible barrier in the opening direction to an acute angle.

2. The clamping device of claim 1, wherein the flexible barrier is confined within the clamping device to limit the range of flexure of the flexible barrier in the opening direction to the acute angle.

3. The clamping device of claim 1, wherein the clamping device comprises an end stop to prevent further flexure of the flexible barrier in the opening direction, beyond the acute angle.

4. The clamping device of claim 3, wherein the end stop comprises an abutment surface contactable by the flexible barrier.

5. The clamping device of claim 3, wherein the flexible barrier becomes more parallel to the end stop as the flexible barrier is deflected in the opening direction.

6. The clamping device of claim 3, wherein in a neutral unflexed state, the flexible barrier extends at a first angle relative to the end stop, and wherein the first angle is an acute angle relative to the end stop.

7. The clamping device of claim 6, wherein the first angle is in a direction that inhibits insertion of the elongate article via the exit aperture, and enables the elongate article to exit the clamping device via the exit aperture.

8. (canceled)

9. The clamping device of claim 6, further comprising a second end stop to prevent flexure of the flexible barrier from the neutral unflexed state in an opposite direction than the opening direction, beyond an acute angle.

10. The clamping device of claim 9, wherein the second end stop comprises an abutment surface contactable by an abutter of the flexible barrier, to limit the flexure to an acute angle.

11. (canceled)

12. The clamping device of claim 1, wherein the exit aperture is adjacent to the entrance aperture by being located to a same end of the clamping device as the entrance aperture, and wherein the flexible barrier blocks the exit aperture but not the entrance aperture.

13. The clamping device of claim 1, wherein the flexible barrier is visible from an exterior of the clamping device, by being closer to the exit aperture than to the clamping device's clamp.

14. The clamping device of claim 1, wherein the flexible barrier comprises a flexible hinge supporting a contact member, wherein the contact member is located relative to the exit aperture to be contactable by the end of the elongate article, wherein force against the contact member of the flexible barrier by the end of the elongate article deflects the contact member in the opening direction to enable the end of the elongate article to leave the clamping device through the exit aperture, and wherein the clamping device is configured to limit a range of flexure of the flexible hinge of the flexible barrier in the opening direction to the acute angle.

15. The clamping device of claim 14, wherein the flexible hinge comprises a living hinge.

16. £ (Original) The clamping device of claim 15, wherein the living hinge is thinner than the contact member, and/or is formed from a same material as the contact member.

17. The clamping device of claim 1, wherein the flexible barrier is enveloped within the body of the clamping device.

18. The clamping device of claim 17, wherein the flexible barrier is enveloped within the body of the clamping device regardless of whether the flexible barrier is closed or is sufficiently open to enable the elongate article to pass through.

19. The clamping device of claim 18, wherein the flexible barrier is enveloped within the body of the clamping device regardless of a position of the flexible barrier within deflection limits of the flexible barrier.

20. (canceled)

21. (canceled)

22. (canceled)

23. The clamping device of claim 1, comprising a part, adjacent to the exit aperture, to which the flexible barrier is mounted, wherein the part also comprises an end cap and/or a spring seat.

24. The clamping device of claim 1, wherein the clamping device comprises a plurality of passages, wherein the entrance aperture and exit aperture are apertures for separate passages of the clamping device, wherein the body of the clamping device defines a plurality of passages configured to receive one or more elongate articles, the plurality of passages comprising a first passage and a second passage, wherein the entrance aperture is a first entrance aperture configured to accessing the first passage, wherein the clamping device further comprises a first exit aperture configured to exiting the first passage, wherein the clamping device further comprises a second entrance aperture configured to access the second passage, wherein the exit aperture is a second exit aperture configured to exit the second passage, wherein the first exit aperture is adjacent the second entrance aperture, and wherein the first entrance aperture and second exit aperture are to the same, first end of the clamping device, and wherein the second entrance aperture and first exit aperture are to a same, second end of the clamping device, opposite the first end of the clamping device.

25. The clamping device of claim 24, further comprising another one of the flexible barrier, proximal to the first exit aperture
